(19) United States
(12) Patent Application Publication
(10) Pub. No.: US 2022/0185624 A1
(43) Pub. Date: Jun. 16, 2022

(54) LEVELING DEVICE OF A PIT, LEVELING METHOD AND ELEVATOR SYSTEM

(71) Applicant: Otis Elevator Company, Farmington, CT (US)

(72) Inventors: Zhenyan Tong, Shanghai (CN); Qirui Wang, Shanghai (CN); Wei Wang, Shanghai (CN)

(21) Appl. No.: 17/392,707

(22) Filed: Aug. 3, 2021

(30) Foreign Application Priority Data
Dec. 11, 2020 (CN) 202011440271.0

(51) Int. Cl. B66B 1/42; B66B 11/00

(52) U.S. Cl. CPC B66B 1/42; B66B 11/0005

(57) ABSTRACT

A pit leveling device for elevators, a leveling method and an elevator system. The pit leveling device includes a base having supporting portions and a plurality of supporting feet, wherein the plurality of supporting feet are detachably disposed below the supporting portions; a plurality of lifting devices disposed below the supporting portions for pushing the supporting portions away from at least a part of the supporting feet during an upward movement; and height compensators detachably disposed in gaps where the supporting portions are pushed away from at least a part of the supporting feet by the lifting devices.

### FOREIGN PRIORITY

This application claims priority to Chinese Patent Application No. 202011440271.0, filed Dec. 11, 2020, and all the benefits accruing therefrom under 35 U.S.C. § 119, the contents of which in its entirety are herein incorporated by reference.

### TECHNICAL FIELD

The present application relates to the field of elevators, and in particular to a pit leveling device for an elevator system and a leveling method therefor.

### BACKGROUND

As a tool for improving the walking of passengers between floors or shortening the walking distance of passengers, passenger transportation devices are very common in daily life. As an example, it is particularly common to use elevators in residential buildings and between floors of commercial buildings.

For a building equipped with an elevator system, it is usually necessary to set up a dedicated hoistway, a pit and other structures for the elevator system in the early stage of construction, and to process and assemble various parts of the elevator at the construction site in the later stage of construction. In addition, a type of modularized elevator is proposed. Most of its components can be processed and pre-assembled in the factory, while only a small amount of processing is required on the construction site to complete the installation of modularized components. As one of the typical application scenarios of this type of modularized elevator, it is particularly suitable for the installation of elevators in old residential buildings. Since the construction of this type of residential area has long been completed, if conventional procedures for on-site processing and assembling of elevators are used in the residential area, it will easily cause great trouble to the residents. The application of modularized elevators can greatly alleviate this problem.

In the application process of modularized elevators, it is necessary to complete the assembly work between multiple modules on site. This kind of on-site stacking and assembling of multiple elevator modules and enabling them to always work vertically relative to the horizontal plane lays the foundation for the stability of the elevator system, and also places higher requirements on the installation personnel.

### SUMMARY

The present application provides a pit leveling device to improve the levelness for assembling elevators on site.

In order to achieve at least one objective of the present application, according to one aspect of the present application, a pit leveling device for elevators is provided, which comprises: a base having supporting portions and a plurality of supporting feet, wherein the plurality of supporting feet are detachably disposed below the supporting portions; a plurality of lifting devices disposed below the supporting portions for pushing the supporting portions away from at least a part of the supporting feet during an upward movement; and height compensators detachably disposed in gaps where the supporting portions are pushed away from at least a part of the supporting feet by the lifting devices.

In addition to one or more of the above features, or as an alternative, in another embodiment, the supporting portions comprise a plurality of outer peripheral edges forming an outer peripheral contour thereof, and each of the supporting feet is disposed at the junction point of adjacent outer peripheral edges.

In addition to one or more of the above features, or as an alternative, in another embodiment, each of the lifting devices is respectively disposed close to the supporting feet below the outer peripheral edges of the supporting portions.

In addition to one or more of the above features, or as an alternative, in another embodiment, each of the lifting devices is respectively disposed below the non-adjacent outer peripheral edges, and the lifting devices are respectively disposed close to the two supporting feet supporting the peripheral edges.

In addition to one or more of the above features, or as an alternative, in another embodiment, the supporting portions are configured as a rectangle, wherein a pair of the lifting devices are respectively disposed below two mutually symmetrical outer peripheral edges of the rectangle, and the pair of the lifting devices are respectively disposed close to the two supporting feet supporting the outer peripheral edges.

In addition to one or more of the above features, or as an alternative, in another embodiment, each of the lifting devices is respectively disposed in the middle of the adjacent supporting feet below the outer peripheral edges of the supporting portions.

In addition to one or more of the above features, or as an alternative, in another embodiment, the supporting portions are configured as a frame, wherein each beam of the frame forms the outer peripheral edges.

In addition to one or more of the above features, or as an alternative, in another embodiment, the combined movement of the plurality of lifting devices is used to push the supporting portions upward along a point formed by one of the supporting feet, push the supporting portions upward along a line formed by a plurality of the supporting feet, or push the supporting portions upward along a surface formed by all the supporting feet.

In addition to one or more of the above features, or as an alternative, in another embodiment, the pit leveling device further comprises: a level calibration device disposed on the supporting portions of the base for indicating the levelness of the supporting portions.

In addition to one or more of the above features, or as an alternative, in another embodiment, the level calibration device comprises a level ruler having a horizontal hollow chamber containing liquid and an air bubble.

In addition to one or more of the above features, or as an alternative, in another embodiment, the height compensator comprises a plurality of shims.

In addition to one or more of the above features, or as an alternative, in another embodiment, the supporting portions and the supporting feet are detachably connected by connecting pieces, and the shims are further provided with receiving notch for accommodating the connecting pieces, wherein the shims are detachably disposed in the gaps between the supporting portions and the supporting feet through the cooperation of the receiving notch and the connecting pieces.

In addition to one or more of the above features, or as an alternative, in another embodiment, the lifting device comprises a hydraulic drive and a quadrilateral hinged link mechanism, wherein the quadrilateral hinged linkage mechanism comprises a support disposed at a first set of relative corners, and a screw passing through a second set of relative corners, and wherein the support supports the supporting portions, and the rotary movement of the screw is converted into the up-and-down movement of the quadrilateral hinged link mechanism.

In order to achieve at least another objective of the present application, according to one aspect of the present application, an elevator system is provided, which comprises: the pit leveling device as described above; and a modularized hoistway frame set up above the pit leveling device that is leveled.

In order to achieve at least another objective of the present application, according to one aspect of the present application, a leveling method for a pit leveling device is provided, wherein the pit leveling device comprises: a base having supporting portions and a plurality of supporting feet, a plurality of lifting devices disposed below the supporting portions; and height compensators, and wherein the leveling method comprises: placing the supporting feet and the supporting portions in a state capable of relative movement; pushing the supporting portions away from at least a part of the supporting feet by the lifting devices, and disposing the height compensators in the gaps between the supporting portions and the supporting feet.

In addition to one or more of the above features, or as an alternative, in another embodiment, the supporting portions comprise a plurality of outer peripheral edges forming an outer peripheral contour thereof, and each of the supporting feet is disposed at the junction point of the adjacent outer peripheral edges. Wherein, the leveling method further comprises: when adjusting the single-point levelness of the pit leveling device, pushing the supporting portions away from a single supporting foot by the lifting devices, and disposing the height compensators in the gap between the supporting portions and the single supporting foot; when adjusting the line levelness of the pit leveling device, pushing the supporting portions away from a plurality of the supporting feet by the lifting devices, and disposing the height compensators in the gaps between the supporting portions and the plurality of supporting feet; or when adjusting the overall height of the pit leveling device, pushing the supporting portions away from all the supporting feet by the lifting devices, and disposing the height compensators in the gaps between the supporting portions and all the supporting feet.

According to the pit leveling device, leveling method, and elevator system of the present application, a base having components that can move relative to each other is provided, and lifting devices are used to drive the components of the base to move relative to each other, and then height compensators are added for compensation. This configuration can enable adjustments to be made properly according to the actual levelness of the pit at the elevator installation site, so as to ensure the levelness of the pit, thereby providing a level and reliable installation foundation for the entire hoistway frame set up on the pit. This configuration is particularly advantageous for modularized elevators or elevators that are later added. At this time, the levelness of the entire elevator system is extremely important to the stability of its structure. Accordingly, the simple and efficient leveling operation brought about by the pit leveling device is also of greater significance.

### BRIEF DESCRIPTION OF THE DRAWINGS

FIG. 1 is a perspective schematic view of an embodiment of a pit leveling device for an elevator system.

FIG. 2 is a perspective schematic view of an embodiment of a lifting device of the pit leveling device shown in FIG. 1.

FIG. 3 is a perspective schematic view of an embodiment of the arrangement of the height compensators of the pit leveling device shown in FIG. 1.

FIG. 4 is a schematic view of an embodiment of a pit leveling device applied to an elevator system.

### DETAILED DESCRIPTION

The present application will be described in detail hereinafter with reference to the exemplary embodiments shown in the accompanying drawings. However, it should be understood that the present application can be implemented in many different forms, and should not be construed as being limited to the embodiments set forth herein. These embodiments are provided here for the purpose of making the disclosure of the present application more complete and comprehensive, and fully conveying the concept of the present application to those skilled in the art.

In addition, for any single technical feature described or implied in the embodiments mentioned herein, or any single technical feature displayed or implied in each drawing, the present application still allows any continued arbitrary combination or deletion of these technical features (or the equivalents thereof) without any technical obstacles, thereby obtaining more other embodiments of the present application that may not be directly mentioned herein.

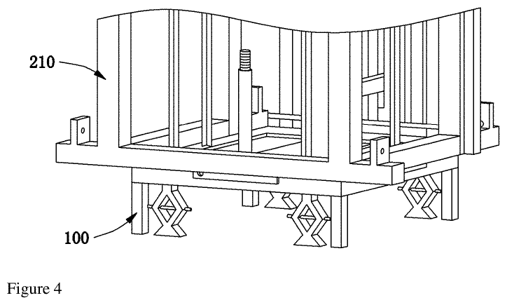

The present application exemplarily describes the pit leveling device and its application scenarios in the elevator system in conjunction with FIGS. 1 to 4. Among them, FIGS. 1 to 3 show the structure and tectonics of the pit leveling device in the form of overall schematic diagrams or partial schematic diagrams, while FIG. 4 generally shows its application scenario in an elevator system. Detailed descriptions are provided as follows.

Referring to FIGS. 1 to 3, the pit leveling device 100 is applied to the pit arrangement of an elevator system. The pit leveling device 100 generally comprises a base 110, lifting devices 120, and height compensators 130. Among them, the base 110 has supporting portions 111 and a plurality of supporting feet 112, which are disposed in a pit in an application scenario. The supporting portions 111 of the base 110 are used to support the modularized hoistway frame to be set up on it, and the plurality of supporting feet 112 are detachably disposed between the supporting portions 111 and the pit as an object to be adjusted in height.

The lifting devices 120 can be configured to be multiple, and they are all disposed below the supporting portions 111, so that by driving the up-and-down movement of one or more of the lifting devices 120, the leveling of the supporting portions at different angles, different directions and different degrees can be achieved. Specifically, each of the lifting devices 120 can function when the supporting feet 112 and the supporting portions 111 are in a detachable state capable of relative movement, so as to push the corresponding supporting feet 112 away from the supporting portions 111.

The height compensators 130 exist as independent components. In the initial state, the supporting portions 111 and the plurality of supporting feet 112 of the base can be firmly connected to each other, and the height compensators 130 are not needed at this time. In the actual application scenario, however, when the levelness needs to be adjusted due to the inclination of the site, etc., in the case where the assemblies of the supporting portions 111 and the plurality of supporting feet 112 are partially disassembled or completely disassembled, and the two are pushed by the lifting devices so that certain gaps are provided between them, height compensators 130 can be inserted in these gaps, so that the entire structure can re-form a stable and reliable connection.

According to the pit leveling device of the present application, a base having components that can move relative to each other is provided, lifting devices are used to drive the relative movement between the components of the base, and height compensators are added to for compensation. This configuration can enable adjustments to be made properly according to the actual levelness of the pit at the elevator installation site, so as to ensure the levelness of the pit, thereby providing a level and reliable installation foundation for the entire hoistway frame to be set up on the pit. This configuration is particularly advantageous for modularized elevators or elevators that are later added. At this time, the levelness of the entire elevator system is extremely important to the stability of its structure. Accordingly, the simple and efficient leveling operation brought about by the pit leveling device is also of greater significance.

The structures of the various components of the pit leveling device and the connection relationships thereof will be continued to be introduced as follows. In addition, in order to further improve reliability, practicability and economy, or out of the considerations for improvement in other aspects, some additional components may be added, which are also exemplified below.

For example, the supporting portions 111 comprise a plurality of outer peripheral edges forming an outer peripheral contour thereof, and each of the supporting feet 112 is respectively disposed at a junction point of adjacent outer peripheral edges. Taking FIG. 1 as an example, at this time, the supporting portions 111 are configured as a rectangular frame 111, and the four beams 111a, 111b, 111c, and 111d of the frame 111 are namely the outer peripheral edges, which collectively enclose to be the outer peripheral contour of the rectangular frame 111. The four supporting feet 112a, 112b, 112c, and 112d are detachably disposed on each of the corners of the rectangular frame 111, respectively. At this time, by adjusting the supporting feet 112 and the rectangular frame 111 to be movably connected, for example, in the form of screwing bolts to create a movable space between the two, and then pushing the rectangular frame 111 by the lifting devices, the adjustment of the rectangular frame 111 can be achieved.

In the application process, it is generally desired that point adjustment, line adjustment or surface adjustment can be made to the rectangular frame 111. Specifically, through the combined movement of a plurality of lifting devices 120, the supporting portions 111 are pushed upward along a point formed by one of the supporting feet 112, thereby achieving point adjustment of the frame. Through the combined movement of a plurality of lifting devices 120, the supporting portions 111 are pushed upward along a line formed by a plurality of supporting feet 112, thereby achieving line adjustment of the frame. Or, through the combined movement of a plurality of lifting devices 120, the supporting portions 111 are pushed upward along a surface formed by all the supporting feet 112, thereby achieving surface adjustment of the frame. With this configuration, the rectangular frame can be leveled in various forms.

In order to achieve the aforementioned different leveling functions, several exemplary arrangements of lifting devices are provided as follows.

For example, referring to FIG. 1, a pair of lifting devices 120a and 120b, and a pair of lifting devices 120c and 120d are respectively provided below the two mutually symmetrical beams 111a and 111c of the rectangular frame 111. Among them, the pair of lifting devices 120a and 120b are respectively disposed close to the two supporting feet 112a and 112b of the beam 111a, and the pair of lifting devices 120c and 120d are respectively disposed close to the two supporting feet 112c and 112d of the beam 111c.

At this time, if only a certain corner of the rectangular frame 111 is below the horizontal plane, for example, the junction point of the beam 111a and the beam 111d is below the horizontal plane, the corner of the frame 111 can be pushed away from the supporting foot 112a by driving the lifting device 120a, until the entire frame is in a horizontal state, and height compensators are disposed in the gap between the supporting foot 112a and the corner of the frame 111, so that the frame is stably maintained at the levelness.

If a certain side of the rectangular frame 111 is below the horizontal plane, for example, the entire beam 111a is below the horizontal plane, the entire beam 111a of the frame 111 can be pushed away from the supporting feet 112a and 112b by driving the lifting devices 120a and 120b, until the entire frame is in a horizontal state, and height compensators are respectively disposed in the gaps between the supporting feet 112a, 112b and the beam 111a of the frame 111, so that the frame is stably maintained at the levelness.

In addition, if two sides of the rectangular frame 111 are below the horizontal plane, for example, the beam 111a and the beam 111b are below the horizontal plane, the two beams 111a and 111b of the frame 111 can be pushed away from the supporting feet 112a, 112b, and 112c by driving the lifting devices 120a, 120b, and 120c, until the entire frame is in a horizontal state, and height compensators are respectively disposed in the gaps between the supporting feet 112a, 112b, 112c and the beams 111a and 111b of the frame 111, so that the frame is stably maintained at the levelness.

Or, when the entire rectangular frame 111 is lower than the set height in the pit, all the beams 111a, 111b, 111c, and 111d of the frame 111 can be pushed away from all the supporting feet 112a, 112b, 112c, and 112d by driving all the lifting devices 120a, 120b, 120c, and 120d at the same time, until the entire frame is at a preset height and in a horizontal state, and height compensators are respectively disposed in the gaps between the supporting feet 112a, 112b, 112c, and 112d and the beams 111a, 111b, 111c, and 111d of the frame 111, so that the frame is stably maintained at the height and levelness.

In addition, as an embodiment not shown in the figures, the lifting devices also have several modifications. For example, each of the lifting devices may be respectively disposed close to the supporting feet below the beams of the supporting portions. For example, the lifting device 120a is still disposed close to the supporting foot 112a under the beam 111a, while the lifting device 120b is changed to be disposed close to the supporting foot 112a under the beam 111b. Thus, a similar leveling effect can also be achieved.

For another example, when the supporting portions have an asymmetrical outer peripheral contour, or has an outer peripheral contour having more than four outer peripheral edges, in order to achieve a similar leveling effect, each of the lifting devices can be respectively disposed below the non-adjacent outer peripheral edges of the supporting portions, and the lifting devices are also respectively disposed close to the two supporting feet supporting the outer peripheral edges.

For still another example, each of the lifting devices can be modified to be respectively disposed in the middle of adjacent supporting feet below the outer peripheral edges of the supporting portions. Thus, a similar leveling effect can also be achieved.

It should be understood that the foregoing embodiments are all listed for illustrative rather than restrictive purposes. For example, although the foregoing embodiments in conjunction with the appended drawings all use a rectangular frame as an example, it is only provided for the purpose of facilitating processing and having a similar contour of the elevator hoistway. Those skilled in the art understand that the aforementioned supporting portions are not necessarily limited to a rectangular shape, nor are they necessarily limited to a frame structure. Even if there is a structural modification, as long as it does not conflict with the arrangement of the lifting devices proposed herein, it can achieve the purpose of leveling.

On the other hand, the pit leveling device can also be provided with a level calibration device 140 for indicating the levelness of the supporting portions 111. Referring to FIG. 1, as an example, the level calibration device may be a level ruler 140 disposed on the supporting portions 111 of the base 110, having a horizontal hollow chamber containing liquid and an air bubble. The levelness of the supporting portions 111 can be confirmed by observing the position of the air bubble in the horizontal hollow chamber during the adjustment process.

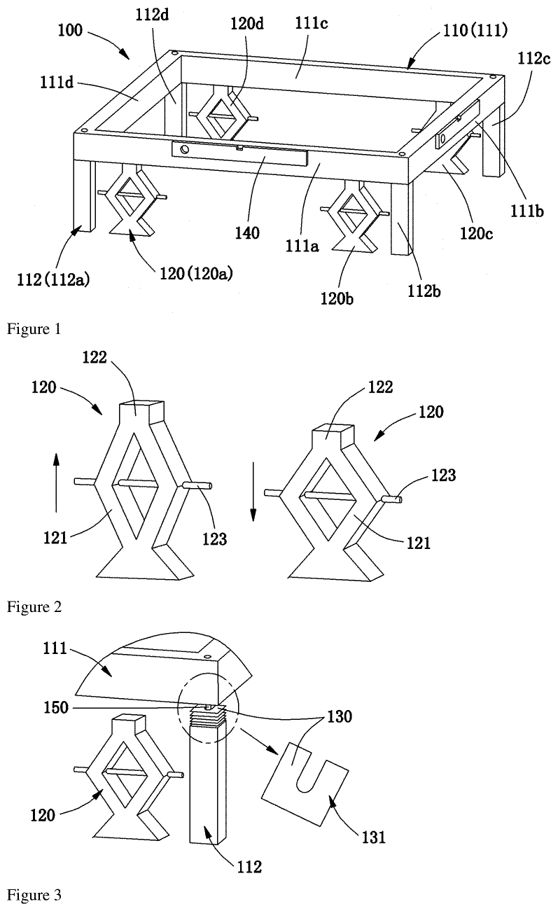

Turning to FIG. 2, as an example, each of the lifting devices 120 comprises a hydraulic drive and a quadrilateral hinged link mechanism 121. The quadrilateral hinged link mechanism 121 comprises a support 122 disposed at a first set of relative corners, and a screw 123 passing through a second set of relative corners. Among them, the support 122 abuts and supports the supporting portion 111, and the rotary movement of the screw 123 is converted into the up-and-down movement of the quadrilateral hinged link mechanism 121.

Furthermore, referring to FIG. 3, as an example of height compensators, they may be configured as a plurality of shims 130 to be inserted when there are gaps between the supporting portions 111 and the supporting feet 112. More specifically, considering that the supporting portions 111 and the supporting feet 112 are detachably connected by connecting pieces 150, such as bolts, the shims 130 may further be provided with receiving notch 131 for accommodating the connecting pieces 150. At this time, when there are gaps between the supporting portions 111 and the supporting feet 112, during the process of inserting the shims 130 into the gaps, the receiving notch 131 of the shims can be made to cooperate with the connecting pieces 150, so that the shims can be more stably disposed in the gaps.

Referring to FIG. 4, an embodiment of an elevator system is further provided herein. The elevator system comprises the pit leveling device 100 in any of the foregoing embodiments or combinations thereof, and therefore has the corresponding technical effects, which will not be repeated here. In addition, the elevator system also comprises a modularized hoistway frame 210 set up above the pit leveling device 100 that is leveled. At this time, the levelness of the entire elevator system is extremely important to the stability of its structure. Accordingly, the simple and efficient leveling operation brought about by the pit leveling device is also of greater significance.

In addition, although not shown in the figures, a leveling method for a pit leveling device is further provided herein, thereby achieving efficient and convenient application of the pit leveling device in any of the foregoing embodiments or combinations thereof. Specifically, the method comprises: placing the supporting feet and the supporting portions in a state capable of relative movement; pushing the supporting portions away from at least a part of the supporting feet by lifting devices; and disposing height compensators in the gaps between the supporting portions and the supporting feet.

More specifically, the method further comprises: when adjusting the single-point levelness of the pit leveling device, pushing the supporting portions away from a single supporting foot by the lifting devices, and disposing the height compensators in the gap between the supporting portions and the single supporting foot; when adjusting the line levelness of the pit leveling device, pushing the supporting portions away from a plurality of the supporting feet by the lifting devices, and disposing the height compensators in the gaps between the supporting portions and the plurality of supporting feet; or when adjusting the overall height of the pit leveling device, pushing the supporting portions away from all the supporting feet by the lifting devices, and disposing the height compensators in the gaps between the supporting portions and all the supporting feet. Applying the pit leveling device in combination with the leveling method, leveling of the pit leveling device at different angles, different ranges and different degrees are achieved.

The above examples mainly illustrate the pit leveling device, leveling method and elevator system of the present application. Although only some of the embodiments of the present application are described, those skilled in the art understand that the present application can, without departing from the spirit and scope of the invention, be implemented in many other forms. Therefore, the illustrated examples and embodiments are to be considered as illustrative but not restrictive, and the present application may cover various modifications or replacements if not departed from the spirit and scope of the present application as defined by the appended claims.

What is claimed is:

1. A pit leveling device for elevators, comprising:
a base having supporting portions and a plurality of supporting feet, wherein the plurality of supporting feet are detachably disposed below the supporting portions;
a plurality of lifting devices disposed below the supporting portions for pushing the supporting portions away from at least a part of the supporting feet during an upward movement; and
height compensators detachably disposed in gaps where the supporting portions are pushed away from at least a part of the supporting feet by the lifting devices.

2. The pit leveling device according to claim 1, wherein the supporting portions comprise a plurality of outer peripheral edges forming an outer peripheral contour thereof, and each of the supporting feet is disposed at the junction point of adjacent outer peripheral edges.

3. The pit leveling device according to claim 2, wherein each of the lifting devices is respectively disposed close to the supporting feet below the outer peripheral edges of the supporting portions.

4. The pit leveling device according to claim 3, wherein each of the lifting devices is respectively disposed below the non-adjacent outer peripheral edges, and the lifting devices are respectively disposed close to the two supporting feet supporting the peripheral edges.

5. The pit leveling device according to claim 4, wherein the supporting portions are configured as a rectangle, wherein a pair of the lifting devices are respectively disposed below two mutually symmetrical outer peripheral edges of the rectangle, and the pair of the lifting devices are respectively disposed close to the two supporting feet supporting the outer peripheral edges.

6. The pit leveling device according to claim 2, wherein each of the lifting devices is respectively disposed in the middle of the adjacent supporting feet below the outer peripheral edges of the supporting portions.

7. The pit leveling device according to claim 2, wherein the supporting portions are configured as a frame, and each beam of the frame forms the outer peripheral edges.

8. The pit leveling device according to claim 1, wherein the combined movement of the plurality of lifting devices is used to push the supporting portions upward along a point formed by one of the supporting feet, push the supporting portions upward along a line formed by the plurality of supporting feet, or push the supporting portion upward along a surface formed by all the supporting feet.

9. The pit leveling device according to claim 1, further comprising: a level calibration device disposed on the supporting portions of the base for indicating the levelness of the supporting portions.

10. The pit leveling device according to claim 9, wherein the level calibration device comprises a level ruler having a horizontal hollow chamber containing liquid and an air bubble.

11. The pit leveling device according to claim 1, wherein the height compensator comprises a plurality of shims.

12. The pit leveling device according to claim 11, wherein the supporting portions and the supporting feet are detachably connected by connecting pieces, and the shims are further provided with receiving notch for accommodating the connecting pieces, and wherein the shims are detachably disposed in the gaps between the supporting portions and the supporting feet through the cooperation of the receiving notch and the connecting pieces.

13. The pit leveling device according to claim 1, wherein the lifting device comprises a hydraulic drive and a quadrilateral hinged link mechanism, wherein the quadrilateral hinged link mechanism comprises a support disposed at a first set of relative corners, and a screw passing through a second set of relative corners, and wherein the support supports the supporting portions, and the rotary movement of the screw is converted into the up-and-down movement of the quadrilateral hinged link mechanism.

14. An elevator system, comprising:
the pit leveling device according to claim 1; and
a modularized hoistway frame set up above the pit leveling device that is leveled.

15. A leveling method for a pit leveling device, wherein the pit leveling device comprises:
a base having supporting portions and a plurality of supporting feet;
a plurality of lifting devices disposed below the supporting portions; and
height compensators,
and wherein the leveling method comprises:
placing the supporting feet and the supporting portions in a state capable of relative movement;
pushing the supporting portions away from at least a part of the supporting feet by the lifting devices; and
disposing height compensators in the gaps between the supporting portions and the supporting feet.

16. The leveling method according to claim 15, wherein the supporting portions comprise a plurality of outer peripheral edges forming an outer peripheral contour thereof, and each of the supporting feet is disposed at the junction point of the adjacent outer peripheral edges, wherein the leveling method further comprises:
when adjusting the single-point levelness of the pit leveling device, pushing the supporting portions away from a single supporting foot by the lifting devices, and disposing the height compensators in the gap between the supporting portions and the single supporting foot;
when adjusting the line levelness of the pit leveling device, pushing the supporting portions away from the plurality of supporting feet by the lifting devices, and disposing the height compensators in the gaps between the supporting portions and the plurality of supporting feet; or
when adjusting the overall height of the pit leveling device, pushing the supporting portions away from all the supporting feet by the lifting devices, and disposing the height compensators in the gaps between the supporting portions and all the supporting feet.
